(19) United States
(12) Patent Application Publication
(10) Pub. No.: US 2005/0036200 A1
(43) Pub. Date: Feb. 17, 2005

(54) Optical encoding/decoding device

(76) Inventors: Mouran Menif, Tunisia (CA); Louis-Patrick Boulianne, Coteau (CA)

Correspondence Address: Baker & Hostetler, Washington Square Suite 1100, 1050 Connecticut Avenue NW, Washington, DC, 20036, US

(21) Appl. No.: 10/475,496

(22) PCT Filed: Apr. 23, 2002
(86) PCT No.: PCT/CA02/00599

Related U.S. Application Data
(60) Provisional application No. 60/285,241, filed on Apr. 23, 2001.

(51) Int. Cl. G02B 5/30; G02B 27/28

(52) U.S. Cl. 359/489

(57) ABSTRACT

An encoding/decoding device for OCDMA communications with an optical network is provided. The device uses a single reflecting element to perform both the encoding of outgoing signal and the decoding of incoming signal. A directional optical assembly allows to differentiate the origin of the signals to forward the outgoing signals after encoding to the network and the incoming signals after decoding to a receiver.

### FIELD OF THE INVENTION

The present invention relates to optical communications and more particularly concerns an optical device using a single reflective element as both an encoder and a decoder.

### BACKGROUND OF THE INVENTION

OCDMA (Optical Code Division Multiple Access) is a multiplexing technique whereby an optical signal is encoded by using several optical wavelengths, which are preferably spread over time. Such a technique was introduced by Fathallah et al. in U.S. pending patent application Ser. No. 09/192,180 entitled “Fast Frequency Hopping Spread Spectrum for Code Division Multiple Access Communications Networks”. A first reflective element is generally used for the encoder, and a is second reflective element having the same reflection pattern as the encoder but time inverted, is used as the decoder. The preferred reflective element for the encoder and the decoder are fibre Bragg gratings (FBG) since they are readily fibre compatible.

Current networks require the provision of two identical reflective elements at each location where encoding and decoding operations are performed. Both operations are traditionally done separately. FIG. 1 (PRIOR ART) shows the architecture of such a network 10, where the central office 12 and every user 14 are provided with both an encoder 16 and a decoder 18, which happen to be identical except for the time-reversal property when time spreading is used. The encoding and decoding of information is a symmetric process as shown in FIG. 2 (PRIOR ART). The same reflective element can be used from the first port to work as an encoder in the Central Office (or at a user station) and from the second port as a decoder at a user station (or at the Central Office).

FIG. 3A (PRIOR ART) illustrates the data flow in a traditional bi-directional encoding/decoding device. In this system, a message sent from the user (via a transmitter) to the Central Office is directed towards the encoder by a three-port circulator C₁. The principle of operation of an optical circulator is well known to those versed in the art. The encoder reflects the signal modified in accordance with its particular code, and sends it back towards the circulator C₁. The signal is then redirected to the bi-directional link between the user and the network to be forwarded to the central office. Similarly, an encoded incoming message from the Central Office will go to circulator C₂ which sends it to the decoder. Reflection by the decoder will decode the signal and send it back to circulator C₂, which redirects it to the receiver.

FIG. 3B (PRIOR ART) illustrates the data flow in a traditional unidirectional network. The principle of operation is similar to that of the device of FIG. 3A, with the exception that two different ports are connected to the network for respectively receiving therefrom and transmitting thereto optical signals. It would however be advantageous to provide a device where both reflecting operations, the encoding and the decoding, could be done by the same element, thereby eliminating the need for extra reflective elements at each location. Of course, the user's reflective element should still be a mirror image of the Central Office's reflective element for the system to be operational.

### OBJECTS AND SUMMARY OF THE INVENTION

It is therefore an object of the present invention to provide an optical encoding/decoding device using a single reflective element for both operations.

It is a preferential object of the invention to provide such a device adapted for bi-directional networks.

It is another preferential object of the invention to provide such a device adapted for unidirectional networks.

Accordingly, the present invention provides an optical encoding/decoding device for a network terminal exchanging encoded outgoing and incoming optical signals with an optical network. The network terminal includes a transmitter for transmitting uncoded outgoing signals and a receiver for receiving decoded incoming signals.

The device includes a reflective element for respectively reflecting the uncoded outgoing signals into the encoded outgoing signals, and reflecting the encoded incoming signals into the decoded incoming signals.

The device also includes a directional optical assembly optically coupled to the transmitter, the receiver, the optical network and the reflective element. The optical assembly receives the uncoded outgoing signals from the transmitter, sends these uncoded outgoing signals through the reflective element to obtain the encoded outgoing signals, and directs these encoded outgoing signals to the network. The optical assembly also receives the encoded incoming signals from the network, sends these encoded incoming signals through the reflective element to obtain the decoded incoming signals, and directs these decoded incoming signals to the receiver.

The present invention also provides an optical encoding/decoding system for a network terminal exchanging encoded outgoing and incoming optical signals with an optical network. The system includes a transmitter for transmitting uncoded outgoing signals, a receiver for receiving decoded incoming signals, and a reflective element for respectively reflecting the uncoded outgoing signals into the encoded outgoing signals, and reflecting the encoded incoming signals into the decoded incoming signals.

The system also includes a directional optical assembly optically coupled to the transmitter, the receiver and the reflective element. The optical assembly receives the uncoded outgoing signals from the transmitter, sends these uncoded outgoing signals through the reflective element to obtain the encoded outgoing signals, and directs these encoded outgoing signals to the network. The optical assembly also receives the encoded incoming signals from the network, sends these encoded incoming signals through the reflective element to obtain the decoded incoming signals, and directs the decoded incoming signals to the receiver.

In accordance with a particularly advantageous embodiment of the invention, the encoding/decoding device and system above use light polarisation as a means to differentiate between incoming and outgoing signals.

Advantageously, the present invention may be used in the context of OCDMA optical communications.

Other features and advantages of the invention will be better understood upon reading of preferred embodiments thereof with reference to the appended drawings.

### BRIEF DESCRIPTION OF THE DRAWINGS

FIG. 1 (PRIOR ART) shows the structure of an optical network having a plurality of users.

FIG. 2 (PRIOR ART) illustrates the principle of an encoder or a decoder using fibre Bragg gratings.

FIG. 3A (PRIOR ART) shows the architecture of a traditional bidirectional encoder/decoder device; FIG. 3B (PRIOR ART) shows the architecture of a traditional unidirectional encoder/decoder device.

FIG. 4 is a general diagram of an optical system according to a preferred embodiment of the present invention.

FIG. 5 is a diagram illustrating the data flow between a network and a user in a system according to a first embodiment of the present invention.

FIG. 6 is a schematic view of an optical encoding/decoding device adapted for a bidirectional network in accordance with a preferred embodiment of the invention.

FIG. 7 is a schematic view of an optical encoding/decoding device adapted for a bidirectional network in accordance with another preferred embodiment of the invention.

FIG. 8 is a schematic view of an optical encoding/decoding device adapted for a unidirectional network in accordance with yet another preferred embodiment of the invention.

FIG. 9 is a schematic view of an optical encoding/decoding device adapted for a unidirectional network in accordance with a further preferred embodiment of the invention.

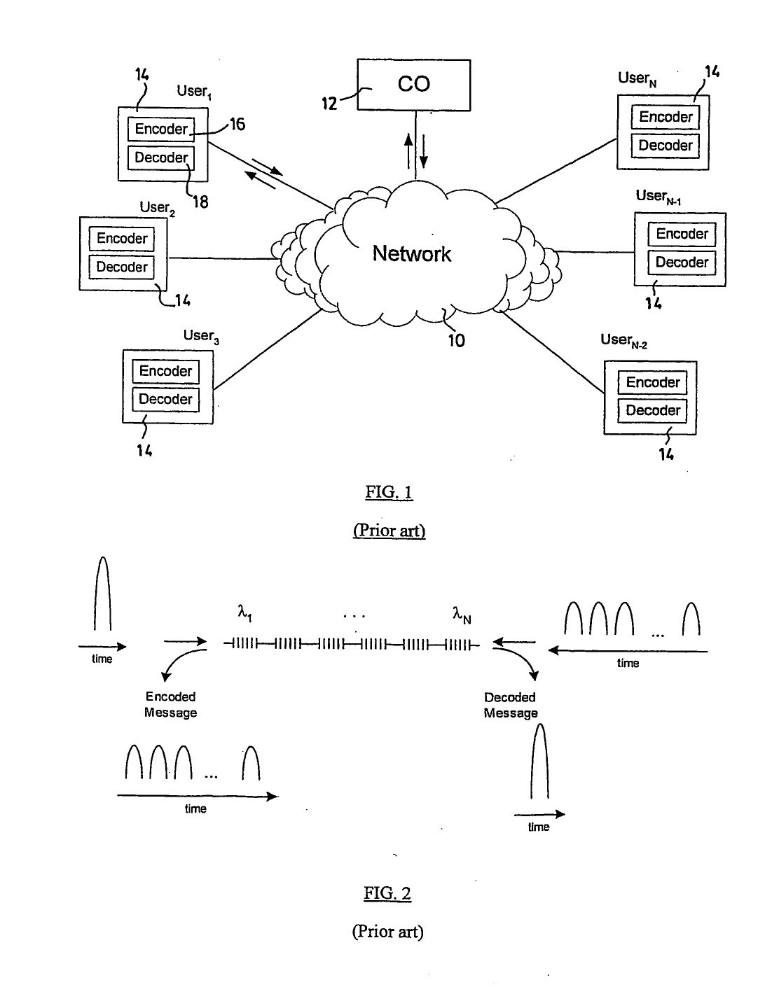

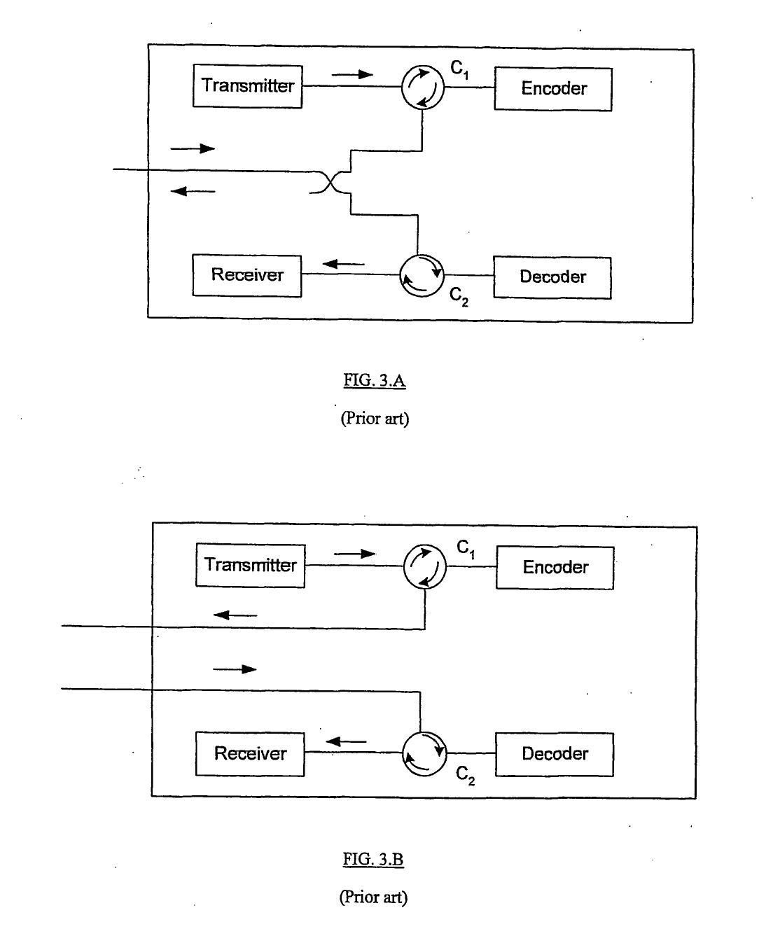

### DESCRIPTION OF PREFERRED EMBODIMENTS OF THE INVENTION

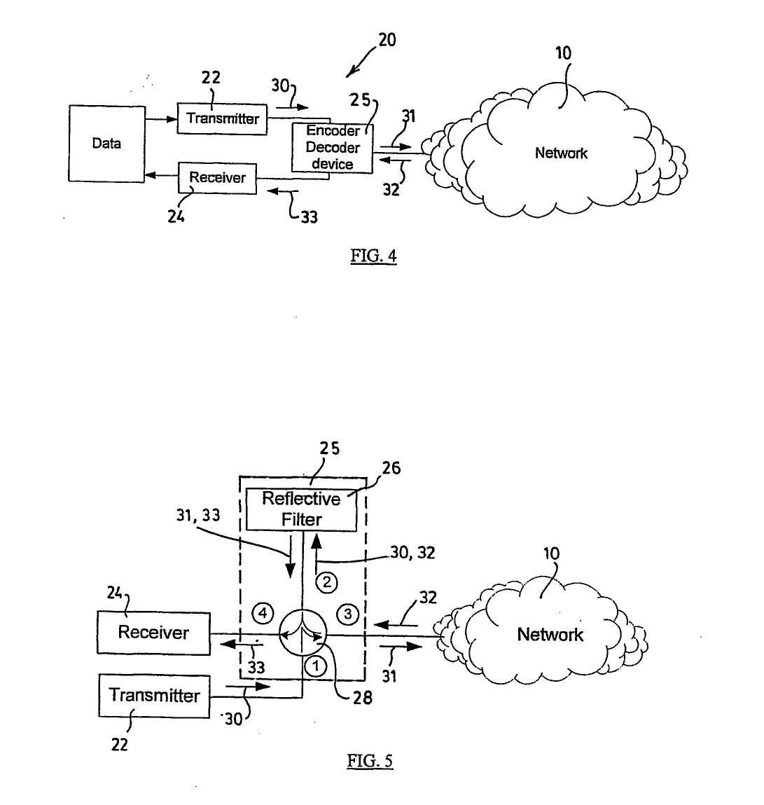

Referring to FIG. 4, there is shown an optical encoding/decoding system 20 in accordance with a preferred embodiment of the present invention. The system allows a network terminal connected to the network 10 to exchange encoded outgoing and incoming signals 31 and 32 with this network.

The system 20 of the present invention includes a transmitter 22 and a receiver 24. The transmitter 22 provides the system with the uncoded outgoing signals 30 and may be embodied by any appropriate transmitter apt to accomplish this function. The uncoded outgoing signals 30 provided by the transmitter 22 are already modulated to incorporate the data message to be sent over the network. The receiver 24 received the decoded incoming signals 33 from the network, and extracts the data message therefrom. Such a device is well known in the art. The optical system 20 further includes an encoding/decoding device 25 in accordance with the present invention. FIG. 5 shows the data flow in such a device according to a preferred embodiment of the invention. The device 25 includes a single reflective element 26, which actually performs the encoding and decoding functions. As such, the reflective element 26 respectively reflects the uncoded outgoing signals 30 into the encoded outgoing signals 31, and reflects the encoded incoming signals 32 into the decoded incoming signals 33. The reflective element is preferably adapted for OCDMA communications. Depending on the encoder used, the transmitter of the present invention may for example be used in “slice and delay” schemes, also called Frequency Hopping (FH), or “spectrum slicing” schemes, also called Frequency Encoding (FE), see for example T. Pfeiffer et al., Electronics Letters, vol. 33, no. 25, pp. 2141-2142, 1997. The present invention could also be applied to other types of optical systems where the add and drop of one channel constitutes the “encoding” and “decoding” of the signal, and needs to be accomplished by a same reflector, such as, for example, in WDM (Wavelength Division Multiplexing) systems or in or Incoherent Wavelength Division Multiplexing (I-WDM) (see for example M. Zirngibl et al., IEEE Photonics Technology Letters, vol. 8, no. 5, pp. 721-723, 1996, for multi-wavelength or single-wavelength output spectra respectively). In the preferred embodiment, the reflective element 26 includes at least one Bragg grating provided in a length of optical fiber, but it could alternatively be embodied by other types of wavelength-dependent reflectors such as thin films reflectors or diffraction grating reflectors.

The encoding/decoding device 25 further includes a directional optical assembly 28. The directional optical assembly 28 is optically coupled to the transmitter 22, the receiver 24, the network 10 and the reflective element 26, and is able, depending on the propagation direction of the light signals, to differentiate their origin so that it may forward each signal to the appropriate output. That is, even though all ports are interrelated, the origin of a signal sent to the reflective element will determine where it will be forwarded after reflection. The directional optical assembly therefore:
receives the uncoded outgoing signals 30 from the transmitter 22, sends these uncoded outgoing signals 30 through the reflective element 26 to obtain the encoded outgoing signals 31, and directs the encoded outgoing signals 31 to the network 10; and
receives the encoded incoming signals 32 from the network 10, sends these encoded incoming signals 32 through the reflective element 26 to obtain the decoded incoming signals 33, and directs the decoded incoming signals 33 to the receiver 24.

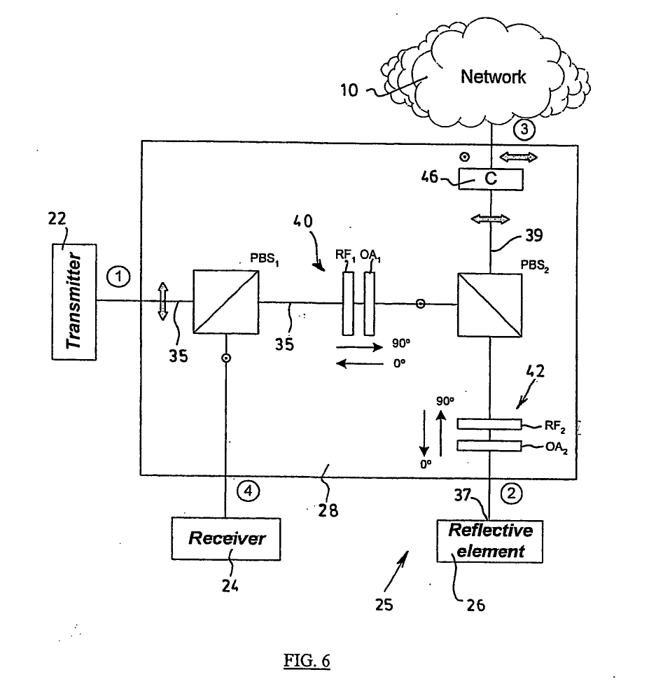

Referring to FIG. 6, there is shown the detailed construction of an encoder/decoder device 25 in accordance with a first preferred embodiment of the invention, for use with a bidirectional network 10. In this case, as the same reflection operation will either encode or decode the reflected signal, the reflective element 26 has a single extremity 37 optically coupled to the directional optical assembly 28 for receiving therefrom the uncoded outgoing signals and encoded incoming signals, and sending back thereto the encoded outgoing signals and decoded incoming signals.

In this embodiment, the directional optical assembly 28 has four ports. Port 1 is connected to the transmitter 22, for receiving therefrom the uncoded outgoing signals. Port 1 is optically coupled to a first path 35 for propagating light within the device 25. Port 2 is connected to the extremity 37 of the reflective element 26. Port 3 is connected to the network 10 for sending thereto the encoded outgoing signals and receiving therefrom the encoded incoming signals. This port is optically coupled to a second path 39 which is itself optically coupled to port 2, and crosses the first path 35. Finally, port 4 is connected to the receiver 24 for sending thereto the decoded incoming signals.

The uncoded outgoing signals received at port 1 of the directional optical assembly 28 are launched along a first path 35, and encounter a first polarisation beamsplitter PBS₁. This component will maintaining the propagation of light polarised along the plane of incidence along the first path 35, but couple light polarised perpendicular to the same plane out of the first path 35. For convenience, light polarised in the plane of incidence will hereinafter be referred to as “horizontally polarised light”, but it is understood that this designation does not refer to any preferential orientation with respect to gravity or otherwise. Similarly, light polarised perpendicular to the plane of incidence will be termed “vertically polarised light”, but again, the use of the expressions “horizontal” and “vertical” is simply intended to designate two planes perpendicular to each other. The uncoded outgoing signals may be already linearly polarised along the plane, depending on the type of transmitter used. In this case it will be unaffected by the first polarisation beam splitter PBS₁ and continue its way along the first path 35 in its entirety. In the case where the signal is not polarised, its vertically polarised component will simply be coupled out of the first path 35 through the unconnected port of the first polarisation beam splitter PBS₁, and be lost to the system. This will result in a 3 dB loss of signal.

In the case where the uncoded outgoing signal is polarised, the fiber between the port 1 and the polarisation beam splitter PBS₁ preferably is a Polarised Mode fiber (PMF) in order to maintain the polarisation state of the incoming signal. If the delivered signal from the transmitter is not polarised, a Standard Mode Fiber (SMF) may be used.

After crossing the first polarisation beam splitter PBS₁, the uncoded outgoing signal then reaches a first polarisation changing element 40, preferably embodied by the combination of a first Faraday rotator RF, and a first optical active element OA₁ (such as a quarter-wave plate). The optically active element rotates the polarisation of the signal by ±45° depending on its propagation direction, whereas the Faraday rotator rotates it by +45° in all cases. The net effect is a 90° polarisation rotation of signals travelling away from port 1, and no modification in the other direction. In this manner, the incoming signal from port 1 will have its polarisation rotated to be perpendicular to its original orientation, and therefore becomes vertically polarised. As such, it will then be redirected on the second path 39 towards port 2 by a second polarisation beam splitter PBS₂, crossing on its way a second polarisation changing element 42 embodied by a second Faraday rotator RF₂ and a second optical active element OA₂ which do not influence signals propagating in this direction.

Port 2 is connected to the reflective element 26 for encoding and decoding signals. As mentioned above, for bi-directional networks, The encoding/decoding device has a single port connected to the network 10 and therefore the reflective element has a single extremity 37 connected to the directional optical assembly 28 for receiving the uncoded outgoing signals and encoded incoming signals and for transmitting the encoded outgoing signals and the decoded incoming signals. In the present case, the uncoded outgoing signal will be encoded, and reflected along the second path 39 as the encoded outgoing signal. It should be noted that at this point, the signal is still vertically polarised. This time it will be affected by the second Faraday rotator RF₂ and the second optical element OA₂, which together rotate its polarisation by 90° so that it becomes horizontally polarised. The signal will therefore be unaffected by the second polarisation beamsplitter PBS₂, and reaches port 3 in order to be transmitted to the Central Office via the network 10.

The present system also serves as a signal decoder in the following manner. An encoded incoming signal is received from the network 10 at port 3, and launched on the second path 39 where an active polarisation controller 46 is provided to align the polarisation components of the incoming signal to be in the plane (horizontally polarised). The active polarisation controller 46 provide an advantageously compensation for the Polarisation Mode Dispersion (PMD) due to the propagation along the transmission fiber. As such, the horizontally polarised signal goes through the second beam splitter PBS₂ unaffected. In the alternative, the active polarisation controller 46 could be omitted, in which case the vertically polarised component of the incoming encoded signals will be redirected to the uncoupled port of the second beam splitter PBS₂ and lost. The horizontally polarised signal is also unmodified by the second Faraday rotator and second optical element RF₂ and OA₂ in direction of port 2. It is then decoded by reflection in the reflective element 26 connected to port 2, becoming the decoded incoming signal. Returning on the second path 39 through the second Faraday rotator and second optical element RF₂ and OA₂, it is this time rotated to be vertically polarised, and as such is deviated from the second path 39 towards the first path 35 by the second beamsplitter PBS₂. It crosses the first Faraday rotator and first optical element RF₁ and OA₁, with no net effect to its polarisation, which is still vertical when it reaches the first beamsplitter PBS₁. It is therefore deviated towards port 4, connected to the receiver 24.

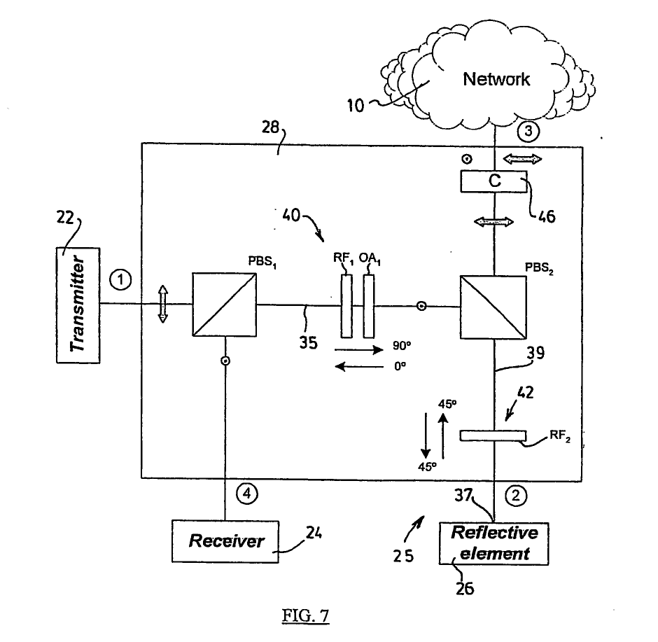

Referring to FIG. 7, there is shown an alternative embodiment of the present invention where the second polarisation changing element 42 is a single Faraday rotator RF2, which rotates the polarisation of light passing therethrough by +45 degrees at each passage, irrespectively of the direction of propagation. The net effect will be a +90 degrees rotation of every signal after passing through the second polarisation changing element back and forth on its way to and from the second reflecting element 26, giving the desired rotation so that the second polarisation beam splitter will properly redirect the signals received from the second port to its proper path.

The above example has been applied to the case of a bi-directional communication system. The present invention may however be equally applied to a uni-directional network, of the type shown in FIG. 3B.

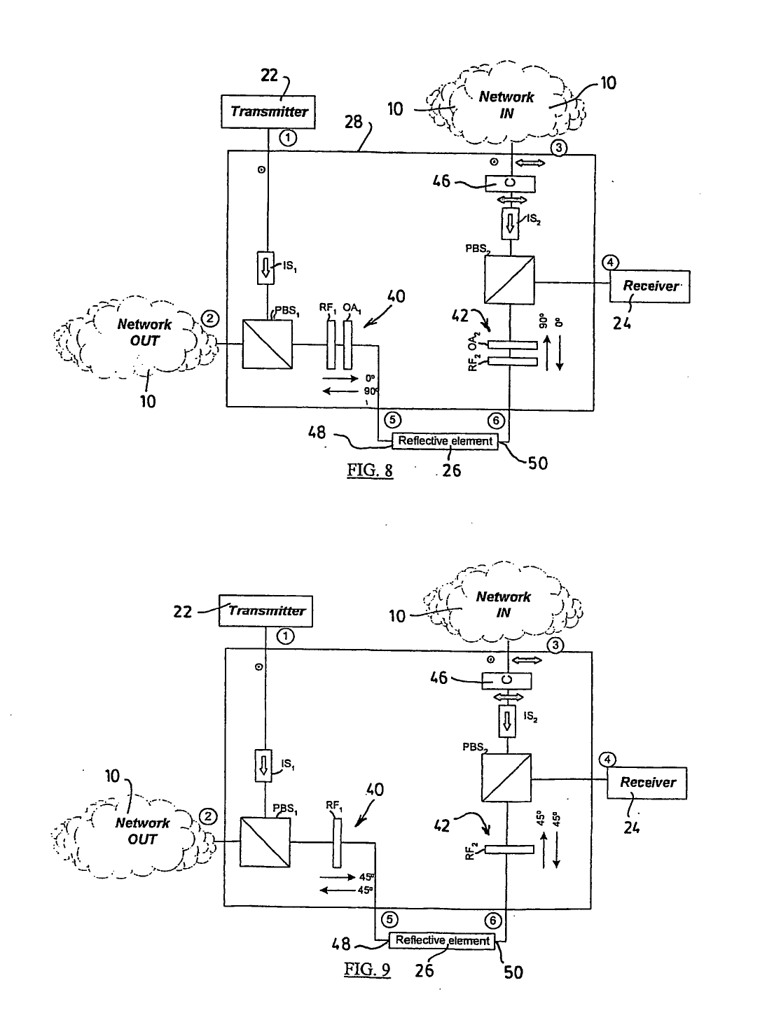

Referring to FIG. 8, there is illustrated a preferred embodiment of an encoding/decoding system 20 adapted for use with a unidirectional network. It will be noted that separate connections to the network, for incoming and outgoing signals, are needed in this embodiment. The system correspondingly needs to have two ports connected to the reflective element 26. For this purpose, the reflective element 26 has a first extremity 48 optically coupled to the directional optical assembly 28, for receiving therefrom the uncoded outgoing signals and transmitting thereto the encoded outgoing signals, and a second extremity 50 opposed to the first extremity 48 and optically coupled to the directional optical assembly 28 for receiving therefrom the encoded incoming signals and transmitting thereto the decoded incoming signals.

The directional optical assembly 28 of this embodiment again has six ports. Port 1 is connected to the transmitter 22 for receiving therefrom the uncoded outgoing signals, and is optically coupled to the first extremity 48 of the reflective element 26. Port 2 is also optically coupled to the first extremity 48 of the reflective element 26, for receiving therefrom the encoded outgoing signals and is connected to the network 10 for sending thereto said encoded outgoing signals. Port 3 is connected to the network 10 for receiving therefrom the encoded incoming signals, and is optically coupled to the second extremity 50 of the reflective element 26. Port 4 is optically coupled to the second extremity 50 of the reflective element 26 for receiving therefrom the decoded incoming signals and connected to the receiver 24 for sending the same thereto. Finally, port 5 is connected to the first extremity 48 of the reflective element 26, and port 6 is connected to its second extremity 50.

Still referring to FIG. 8, there is shown a preferred embodiment of the directional optical assembly 28 in the present case. It will be noted that the assembly 28 in this case includes the same components as the assembly of FIG. 6, but arranged differently. First and second isolators IS₁ and IS₂ have also been added respectively near port 1 and port 3, for a purpose which will become apparent from the description below.

It can be seen that an uncoded incoming signal from the transmitter 22 at port 1 is first propagating throw a SMF or PMF fiber depending to polarisation state of the uncoded incoming signal. In polarised case, the uncoded signal coming form the transmitter 22 have to be perpendicular to the plane of incidence (vertically polarised). As such, only the vertically polarised uncoded incoming signal is redirected by a first polarisation beam splitter PBS, in the right-handed direction on FIG. 8, that is towards the reflective element 26. It will be unaffected by the first polarisation changing element 40 embodied by the first Faraday rotator RF₁ and the first optically active element OA₁, and reaches port 5 at the first extremity 48 of the reflective element 26. Part of the signal will be encoded by reflection in the reflective element 26, becoming the encoded outgoing signal, and returned back on its previous path. This time, its polarisation will be rotated by the first Faraday rotator RF₁ and first optically active element OA₁ to become horizontal. It will therefore go through the first beamsplitter PBS, unaffected and reach port 2 which is connected to the network 10.

It should be noted that in this embodiment, the portion of the signal not reflected by the reflective element 26 will exit at port 6 and continue on its path where it will encounter the second polarisation changing element 42 embodied by the second Faraday rotator RF₂ and the second optically active element OA₂, and have its polarisation rotated to be horizontal. As such, it crosses a second beamsplitter PBS₂ unaffected, and is stopped by the second isolator IS₂.

Encoded incoming signals are received from the network 10 at port 3. They are aligned through an active polarisation controller 46 to have all their polarisation components in the plane (horizontally polarised). As such, they will be unaffected by the second beam splitter PBS₂, and continue on their path crossing the second Faraday rotator RF₂ and second optically active element OA₂ with no net effect, and reach port 6 connected to the second extremity 50 of the reflective element 26. In the case where no polarisation combiner is used, the encoded signal will drop by a 3dB after crossing the second beam splitter PBS₂. Again, a portion of the signal will be reflected by the reflective element 26, and therefore provide the decoded incoming signal, and a residual signal will exit through port 5 of the reflective element 26. The decoded signal goes back on its way and has its polarisation rotated to become vertical by the second Faraday rotator RF₂ and second optically active element OA₂, and is therefore deviated by the second beamsplitter PBS₂ to exit from port 4, connected to the receiver 24. The residual signal is still horizontally polarised, but will be affected by the first Faraday rotator RF₁ and first optically active element OA₁ to become vertically polarised. It will therefore be reflected towards port 1 by the first beamsplitter PBS₁, but stopped in its path by the first isolator IS₁.

Referring to FIG. 9, there is shown an alternative embodiment of the present invention where the polarisation of signal is changed in the first and second polarisation changing elements 40 and 42 using only one Faraday rotator, with a +45° in each direction instead of using a Faraday rotator and an optical active element. This substitution is made possible by the fact that all the signals have to propagate throw two polarisation changing elements in all cases. It is therefore only necessary to have a 90 degrees polarisation rotation after two passages through a polarisation changing element, irrespectively of the propagation direction.

Of course, numerous modifications could be made to the above described embodiments without departing from the scope of the present invention as defined in the appended claims.

1. An optical encoding/decoding device for a network terminal exchanging encoded outgoing and incoming optical signals with an optical network, said network terminal including a transmitter for transmitting uncoded outgoing signals and a receiver for receiving decoded incoming signals, the device comprising:
a reflective element for respectively reflecting the uncoded outgoing signals into the encoded outgoing signals, and reflecting the encoded incoming signals into the decoded incoming signals; and
a directional optical assembly optically coupled to the transmitter, the receiver, the network and the reflective element, said optical assembly:
receiving the uncoded outgoing signals from the transmitter, sending said uncoded outgoing signals through the reflective element to obtain the encoded outgoing signals, and directing said encoded outgoing signals to the network; and
receiving the encoded incoming signals from the network, sending said encoded incoming signals through the reflective element to obtain the decoded incoming signals, and directing said decoded incoming signals to the receiver.

2. The optical encoding/decoding device according to claim 1, wherein the reflective element is an Optical Code Division Multiple Access (OCDMA) encoder/decoder.

3. The optical encoding/decoding device according to claim 1, wherein the reflective element has a single extremity optically coupled to the directional optical assembly for receiving therefrom the uncoded outgoing signals and encoded incoming signals and sending back thereto the encoded outgoing signals and decoded incoming signals.

4. The optical encoding/decoding device according to claim 3, wherein said directional optical assembly includes:
a first port connected to the transmitter for receiving therefrom the uncoded outgoing signals and being optically coupled to a first path;
a second port connected to the extremity of the reflective element;
a third port connected to the network for sending thereto the encoded outgoing signals and receiving therefrom the encoded incoming signals, said third port being optically coupled to a second path optically coupled to the second port and crossing the first path; and
a fourth port connected to the receiver for sending thereto the decoded incoming signals.

5. The optical encoding/decoding device according to claim 4, wherein said directional optical assembly comprises a first polarisation beam splitter disposed in the first path, said first polarisation beam splitter maintaining a propagation of horizontally polarised light along said first path and coupling vertically polarised light out of the first path, vertically polarised light travelling along the first path towards the first port being redirected towards the fourth port.

6. The optical encoding/decoding device according to claim 5, further comprising polarising means for horizontally polarising the encoded incoming signals optically coupled to the second path.

7. The optical encoding/decoding device according to claim 6, wherein the directional optical assembly comprises an active polarisation controller optically coupled to the third port for aligning polarisation components of the encoded incoming signals received at the third port into horizontally polarised light, said active polarisation controller defining the polarising means.

8. The optical encoding/decoding device according the claim 7, wherein said directional optical assembly comprises a second polarisation beam splitter disposed at a crossing point of the first and the second path, said second polarisation beam splitter optically coupling vertically polarised light between the first path and a portion of the second path optically coupled to the second port and maintaining a propagation of horizontally polarised light along the first and the second paths.

9. The optical encoding/decoding assembly according to claim 8, wherein the directional optical assembly further comprises a first polarisation changing element disposed in the first path between the first and second polarisation beam splitters for rotating by 90 degrees the polarisation of light travelling away from the first port without affecting light travelling towards said first port;

10. The optical encoding/decoding device according to claim 9, a second polarisation changing element disposed in the second path between the second beamsplitter and the second port, for rotating by 90 degrees the polarisation of light passing twice therethrough while propagating to and back from the reflective element.

11. The optical encoding/decoding device according to claim 10, wherein the first polarisation changing element comprises:
a quarter-wave plate rotating by +45 degrees the polarisation of light travelling away from the first port and by −45 degrees the polarisation of light travelling towards the first port; and
a Faraday rotator rotating by +45 degrees the polarisation of light travelling away from and towards the first port.

12. The optical encoding/decoding device according to claim 10, wherein the second polarisation changing element comprises:
a quarter-wave plate rotating by +45 degrees the polarisation of light travelling away from the second port and by −45 degrees the polarisation of light travelling towards the second port; and
a Faraday rotator rotating by +45 degrees the polarisation of light travelling away from and towards the second port.

13. The optical encoding/decoding element according to claim 10, wherein the second polarisation changing element comprises:
a Faraday rotator rotating by +45 degrees the polarisation of light travelling away from and towards the second port.

14. The optical encoding/decoding device according to claim 1, wherein the reflective element comprises:
a first extremity optically coupled to the directional optical assembly for receiving therefrom the uncoded outgoing signals and transmitting thereto the encoded outgoing signals; and
a second extremity opposed to the first extremity and optically coupled to the directional optical assembly for receiving therefrom the encoded incoming signals and transmitting thereto the decoded incoming signals.

15. The optical encoding/decoding device according to claim 14, wherein the directional optical assembly comprises:
a first port connected to the transmitter for receiving therefrom the uncoded outgoing signals, said first port being optically coupled to the first extremity of the reflective element;
a second port optically coupled to the first extremity of the reflective element for receiving therefrom the encoded outgoing signals and connected to the network for sending thereto said encoded outgoing signals;
a third port connected to the network for receiving therefrom the encoded incoming signals and optically coupled to the second extremity of the reflective element;
a fourth port optically coupled to the second extremity of the reflective element for receiving therefrom the decoded incoming signals and connected to the receiver for sending thereto said decoded incoming signals;
a fifth port connected to the first extremity of the reflective element; and
a sixth port connected to the second extremity of the reflective element.

16. The optical encoding/decoding device according to claim 15, further comprising: polarising means for horizontally polarising the encoded incoming signals received at the third port.

17. The optical encoding/decoding device according to claim 16, wherein the directional optical assembly comprises an active polarisation controller disposed downstream the third port for aligning polarisation components of the encoded incoming signals received at said third port into horizontally polarised light, said third port polarisation controller defining the polarising means.

18. The optical encoding/decoding device according the claim 16, wherein said directional optical assembly comprises:
a first polarisation changing element disposed upstream the first extremity of the reflective element for rotating by 90 degrees the polarisation of light travelling away from the first extremity of the reflective element without affecting light travelling towards said first extremity of the reflective element; and
a first polarisation beam splitter disposed between the first port and the first polarisation changing element for optically coupling vertically polarised light between the first port and the first extremity of the reflective element and optically coupling horizontally polarised light between said first extremity of the reflective element and the second port;
said directional optical assembly further comprising:
a second polarisation changing element disposed upstream the second extremity of the reflective element for rotating by 90 degrees the polarisation of light travelling away from the second extremity of the reflective element without affecting light travelling towards said second extremity of the reflective element; and
a second polarisation beam splitter disposed between the third port and the second polarisation changing element for optically coupling horizontally polarised light between the third port and the second extremity of the reflective element and optically coupling vertically polarised light between said second extremity of the reflective element and the fourth port.

19. The optical encoding/decoding device according to claim 18, wherein the directional optical assembly further comprises:
a first isolator disposed between the first port and the first polarisation beam splitter for blocking light travelling towards said first port; and
a second isolator disposed between the third port and the second polarisation beam splitter for blocking light travelling towards said third port.

20. The optical encoding/decoding device according to claim 18, wherein the first polarisation changing element comprises:
a quarter-wave plate rotating by +45 degrees the polarisation of light travelling away from the first extremity of the reflecting element and by −45 degrees the polarisation of light travelling towards said first extremity of the reflective element; and
a Faraday rotator rotating by +45 degrees the polarisation of light travelling away from and towards the first extremity of the reflective element.

21. The optical encoding/decoding device according to claim 18, wherein the second polarisation changing element comprises:
a quarter-wave plate rotating by +45 degrees the polarisation of light travelling away from the second extremity of the reflective element and by −45 degrees the polarisation of light travelling towards the second extremity of the reflective element; and
a Faraday rotator rotating by +45 degrees the polarisation of light travelling away from and towards the second extremity of the reflective element.

22. The optical encoding/decoding device according the claim 16, wherein said directional optical assembly comprises:
a first polarisation changing element disposed upstream the first extremity of the reflective element for rotating by 45 degrees the polarisation of light travelling therethrough; and
a first polarisation beam splitter disposed between the first port and the first polarisation changing element for optically coupling vertically polarised light between the first port and the first extremity of the reflective element and optically coupling horizontally polarised light between said first extremity of the reflective element and the second port;
said directional optical assembly further comprising:
a second polarisation changing element disposed upstream the second extremity of the reflective element for rotating by 45 degrees the polarisation of light travelling therethrough; and
a second polarisation beam splitter disposed between the third port and the second polarisation changing element for optically coupling horizontally polarised light between the third port and the second extremity of the reflective element and optically coupling vertically polarised light between said second extremity of the reflective element and the fourth port.

23. The optical encoding/decoding device according to claim 22, wherein the directional optical assembly further comprises:
a first isolator disposed between the first port and the first polarisation beam splitter for blocking light travelling towards said first port; and
a second isolator disposed between the third port and the second polarisation beam splitter for blocking light travelling towards said third port.

24. The optical encoding/decoding device according to claim 22, wherein the first polarisation changing element comprises a Faraday rotator.

25. The optical encoding/decoding device according to claim 22, wherein the second polarisation changing element comprises a Faraday rotator.

26. An optical encoding/decoding system for exchanging encoded outgoing and incoming optical signals with an optical network, said system comprising:
a transmitter for transmitting uncoded outgoing signals;
a receiver for receiving decoded incoming signals;
a reflective element for respectively reflecting the uncoded outgoing signals into the encoded outgoing signals, and reflecting the encoded incoming signals into the decoded incoming signals; and
a directional optical assembly optically coupled to the transmitter, the receiver, the network and the reflective element, said optical assembly:
receiving the uncoded outgoing signals from the transmitter, sending said uncoded outgoing signals through the reflective element to obtain the encoded outgoing signals, and directing said encoded outgoing signals to the network; and
receiving the encoded incoming signals from the network, sending said encoded incoming signals through the reflective element to obtain the decoded incoming signals, and directing said decoded incoming signals to the receiver.
